(19) United States
(12) Patent Application Publication
(10) Pub. No.: US 2008/0197324 A1
(43) Pub. Date: Aug. 21, 2008

(54) OPHTHALMIC COMPOSITION CONTAINING A POLYOL-ACID COPOLYMER

(76) Inventors: Fang Zhao, Rochester, NY (US); Vicki L. Barniak, Fairport, NY (US); Weihong Lang, Amston, CT (US); Kimberly Millard, Rochester, NY (US); Yu-Chin Lai, Pittsford, NY (US)

Correspondence Address: Joseph Barrera;Bausch & Lomb Incorporated, One Bausch & Lomb Place, Rochester, NY, 14604, US

(21) Appl. No.: 11/751,806

(22) Filed: May 22, 2007

Related U.S. Application Data
(63) Continuation-in-part of application No. 11/676,599, filed on Feb. 20, 2007.

(51) Int. Cl. C08L 101/06; C09K 3/00

(52) U.S. Cl. 252/380; 523/122

(57) ABSTRACT

An ophthalmic composition comprising a copolymer and one or more cationic antimicrobial components. The copolymer comprises monomeric units of one or more polymerizable alcohols or polymerizable polyols, and monomeric units of one or more polymerizable carboxylic acids. Also, the composition has an osmolality from 200 mOsmol/kg to 400 mOsmol/kg.

This application is a continuation-in-part application of U.S. patent application Ser. No. 11/676,599, filed Feb. 20, 2007, the entire disclosure of which is incorporated herein by reference.

The invention relates to a copolymer prepared from a polymerizable polyol and a polymerizable carboxylic acid and the use of the copolymer in an ophthalmic composition.

### BACKGROUND OF THE INVENTION

During normal use, contact lenses are soiled or contaminated with a wide variety of compounds that can degrade lens performance. For example, during use a contact lens will become soiled with biological materials such as proteins or lipids that are present in the tear fluid and which adhere to the lens surface. Also, by handling of the contact lens, sebum (skin oil) or cosmetics or other materials can soil the contact lens. These contaminants affect visual acuity and patient comfort, and can provide a more favorable environment for microbes on the lens surface. Accordingly, it is important to remove any debris from the lens surface and to disinfect the lens for safe and comfortable use. A care regimen for contact lenses typically involves various functions such as disinfection and cleaning.

Typically, a lens care solution includes a disinfectant to kill any microbes, and wetting or comfort agents to condition (e.g., lubricate or cushion) the lens surface so the lens is more comfortable in the eye. Some users of contact lenses may also need to rewet the lens during use by administering to the eye a solution commonly referred to as rewetting drops.

### SUMMARY OF THE INVENTION

The invention is directed to an ophthalmic composition comprising a copolymer and one or more antimicrobial components. The copolymer comprises monomeric units of one or more polymerizable alcohols or polymerizable polyols, and monomeric units of one or more polymerizable carboxylic acids. Also, the composition has an osmolality from 200 mOsmol/kg to 400 mOsmol/kg.

### DETAILED DESCRIPTION OF THE INVENTION

Polymers with an overall negative charge, for example, poly(acrylic acid), commercially available under the tradename Carbomer®, are known mucoadhesive and humectant components that can be used in ophthalmic compositions such as contact lens solutions. Their application in such compositions, however, is limited due to the incompatibility with commonly used cationic antimicrobial components such as hexamethylene biguanides, alexidine and polyquaternium-1. The complexation of the cationic antimicrobial component with the anionic polymer is believed to cause the observed reduction in antimicrobial efficacy. As a result, greater concentrations of the cationic antimicrobial components are required, which can have a negative impact on patient comfort.

Applicants have discovered that by reducing the concentration of negative charges on a humectant polymer one can reduce the unwanted affect of reduced biocidal efficacy, yet maintain the overall comfort level of the patient. This is achieved by adding a copolymer that includes monomeric units of polymerizable polyols or polymerizable alcohols and monomeric units of a molymerizable carboxylic acid. The resulting copolymer exhibits the desirable mucoadhesive and humectant properties similar to polyacid, e.g., Carbomer®, however the effective negative charge density of the copolymer is significantly reduced compared to the homopolymer of the polyacid. The reduced charge density is believed to mitigate the complexation of the polyacid to the cationic antimicrobial component, and thus, there is little, if any, reduction in antimicrobial efficacy.

In addition, the copolymer provides a means by which one of ordinary skill can adjust or balance the mucoadhesive and humectant properties with the antimicrobial properties of the ophthalmic composition. The charge density can be controlled by carefully setting the monomer ratio of the polymerizable polyol/alcohol to the polymerizable carboxylic acid in the copolymer.

The invention is directed to an ophthalmic composition that includes a copolymer comprising monomeric units of one or more polymerizable alcohols or polymerizable polyols, and monomeric units of one or more polymerizable carboxylic acids. The composition also includes one or more antimicrobial components, and will have an osmolality from 200 mOsmol/kg to 400 mOsmol/kg.

The term “ophthalmic composition” is defined by a composition intended for application in the eye or intended for treating a device to be placed in contact with the eye such as a contact lens. Ophthalmic compositions can include compositions for direct placement in the eye and include eye drop solutions such as for treating dry eye. Ophthalmic compositions also include those compositions formulated as multi-purpose solutions for cleaning and disinfecting contact lenses or to package contact lenses.

The term “polymerizable alcohol” refers to monomeric units with one hydroxy group. The term also includes polymerizable vinyl epoxides, which at a pH of about 7 provides the requisite hydroxyl functional group. The term “polymerizable polyol” refers to monomeric units with two or more hydroxy groups. The term “carboxylic acids” includes compounds that are capable of being converted into carboxylic acids, for example, vinyldimethyloxozalone (VDMO) and corresponding anhydrides.

In one embodiment, the copolymer has a mole ratio of monomeric units of the polymerizable alcohol or polymerizable polyol to the monomeric units of the polymerizable carboxylic acid of from 2 to 20, from 4 to 16 or from 6 to 16.

Exemplary polymerizable polyols can be selected from the group consisting of erythritol (meth)acrylate, xylitol (meth)acrylate, sorbitol (meth)acrylate, and derivatives thereof. Exemplary polymerizable alcohols are selected from the group consisting of glyceryl (meth)acrylate, 4-vinylcyclohexyl-1,2-epoxide, vinyl alcohol and derivatives thereof. The term “(meth)acrylate” means methacrylate or acrylate.

Exemplary polymerizable carboxylic acids are selected from (meth)acrylic acids or alkenoic acids and derivatives thereof. The alkenoic acids comprise four to ten carbon atoms. The alkenoic acids are selected from the group consisting of maleic acid, fumaric acid, itaconic acid and derivatives thereof (such as maleic anhydride, fumaric anhydride, itaconic anhydride). Other monomeric units of polymerizable carboxylic acids are selected from the group consisting of vinyl derivatives of carboxyalkyl cellulose, vinyl derivatives of glutamic acid and vinyl derivatives of aspartic acid.

One of the preferred copolymers consists essentially of monomeric units of (meth)acrylic acid and monomeric units of xylitol methacrylate (such as, for example, xylitol 1-methacrylate or xylitol 3-methacrylate). Another preferred copolymer consists essentially of monomeric units of (meth)acrylic acid and monomeric units of sorbitol methacrylate. Still another preferred copolymer consists essentially of monomeric units of (meth)acrylic acid and monomeric units of glyceryl methacrylate

The polymerizable polyols are prepared by reacting (meth)acryloyl chloride with the desired alcohol or polyol using a mole ratio of (meth)acryloyl chloride to alcohol/polyol of from 1:1 or less in the presence of a weak base, e.g., triethylamine. The alcohol/polyol (meth)acrylate can be separated and further purified using chromatography such as HPLC.

The invention is also directed to an ophthalmic composition that includes a copolymer comprising monomeric units of N-vinyl pyrrolidone (NVP) and monomeric units of one or more polymerizable carboxylic acids. The composition has an osmolality from 200 mOsmol/kg to 400 mOsmol/kg.

In one embodiment, the copolymer has a mole ratio of monomeric units of NVP to the monomeric units of the polymerizable carboxylic acid from 2 to 20, from 4 to 16 or from 6 to 16.

The ophthalmic compositions of the invention containing one or more of the copolymers described above can be formulated as a contact lens solution, which is used to disinfect, clean or package contact lenses. In particular, the ophthalmic composition can be formulated as a multipurpose contact lens solution containing several of the formulation components described below.

The ophthalmic compositions also include an antimicrobial component. Most of the preferred compositions will include a cationic antimicrobial component. The term “cationic” when referring to an antimicrobial component refers to the predominant form of the antimicrobial component at neutral pH having a positive charge and a counteranion.

The cationic antimicrobial components include chemicals which derive their antimicrobial activity through a chemical or physiochemical interaction with microbes or microorganisms such as those contaminating a contact lens. Suitable cationic antimicrobial components are those generally employed in ophthalmic applications and include, but are not limited to, quaternary ammonium salts such as cetylpyridinium chloride, α-[4-tris(2-hydroxyethyl)ammonium chloride-2-butenyl]poly[1-dimethylammonium chloride-2-butenyl]-ω-tris(2-hydroxyethyl)ammonium chloride (available as polyquaternium-1from Stepan Corporation), benzalkonium halides, and biguanides such as salts of alexidine, alexidine-free base, salts of chlorhexidine, hexamethylene biguanides and salts thereof and their polymers such as poly(hexamethylene biguanide) (PHMB) or PHMB-CG. Another antimicrobial component that can be used in the composition is myristamidopropyl dimethylamine (Aldox®). An exemplary list of cationic disinfecting antimicrobial components include cetylpyridinium chloride, α-[4-tris(2-hydroxyethyl)ammonium chloride-2-butenyl]poly[1-dimethylammonium chloride-2-butenyl]-ω-tris(2-hydroxyethyl)ammonium chloride, poly(hexamethylene biguanide) (PHMB), PHMB-CG, and any mixture thereof.

PHMB is best described as a polymeric biguanide composition comprising at least six biguanide polymers each with a different combination of terminal guanidine, cyanoguanidino or amine terminal groups. Accordingly, a commercial sample of PHMB will likely comprise a mixture of various polymeric biguanides with the three mentioned terminal groups. The biguanides differ with respect to which terminal groups are arranged on the polymer and what are the molar concentrations of each terminal group in the mixture. PHMB (Cosmocil® type PHMB) can contain from 20 mol % to 30 mol % terminal amine groups. The molar concentration of terminal guanidine groups and terminal cyanoguanidino groups range from 38 mol % to 49 mol % and 30 mol % to 32 mol %, respectively.

A new synthetic route to polymeric biguanide compositions is described in copending U.S. provisional application Ser. Nos. 60/853,579 filed Oct. 23, 2006, and 60/895770 filed Mar. 20, 2007. The new synthetic route provides a polymeric biguanide composition comprising less than 18 mol % of terminal amine groups as measured by ¹³C NMR. The polymeric biguanide composition also is characterized by a relative increase in the molar concentration of terminal guanidine groups or terminal cyanoguanidino groups. For example, in one embodiment, the biguanide composition comprises less than 18 mol % of terminal amine groups, and 55 mol % or greater of terminal guanidine groups. In another embodiment, the biguanide composition comprises less than 18 mol % of terminal amine groups, and 40 mol % or greater of terminal cyanoguanidino groups.

In this application we refer to this novel polymeric biguanide composition as PHMB-CG. We also refer to polymeric biguanide compositions in the generic sense as “hexamethylene biguanides” , which one of ordinary skill in the art would recognize to include both PHMB as well as PHMB-CG.

The antimicrobial component is present in an amount from 0.01 ppm to 100 ppm, from 0.1 ppm to 50 ppm or from 0.1 ppm to 10 ppm. It is preferred, however, that the amount of antimicrobial component that is used is effective in disinfecting contact lenses contacted with the compositions, while at the same time promote lens patient comfort and acceptability.

In one embodiment, the primary antimicrobial component present in the lens care solutions is a hexamethylene biguanide, which is present from 0.01 ppm to 3 ppm. In another embodiment, the primary antimicrobial component present in the lens care solution is α-[4-tris(2-hydroxyethyl)ammonium chloride-2-butenyl]poly[1-dimethylammonium chloride-2-butenyl]-ω-tris(2-hydroxyethyl)ammonium chloride, which is present from 1 ppm to 100 ppm.

In addition, any one mixture of two antimicrobial components can be present in the lens care solutions. For example, a particular lens care solution can include from 0.3 ppm to 0.8 ppm of a hexamethylene biguanide, and 10 ppm to 60 ppm α-[4-tris(2-hydroxyethyl)ammonium chloride-2-butenyl]poly[1-dimethylammonium chloride-2-butenyl]-ω-tris(2-hydroxyethyl)ammonium chloride.

The ophthalmic compositions can also include a fatty acid monoester. The fatty acid monoester comprises an aliphatic fatty acid portion having ten carbon atoms, and an aliphatic hydroxyl portion. In some instances, and depending upon the particular type of contact lens, the presence of the fatty acid monoester can enhance the efficacy against Candida albicans or Fusarium solani.

The ophthalmic compositions can also include hyaluronic acid or the corresponding metal salts including, for example, sodium hyaluronate (the sodium salt), potassium hyaluronate, magnesium hyaluronate, and calcium hyaluronate (hereafter, collectively as hyaluronic acid). Hyaluronic acid is a natural polymer comprising repeating disaccharide units (glucuronic acid and, N-acetyl glycosamine). Hyaluronic acid is produced in the body by connective tissue cells of most animals, and is present in large amounts in such tissues as the vitreous humor of the eye and the synovial fluids of joints.

Hyaluronic acid can be isolated from natural sources and can be obtained from commercial suppliers. Alternatively, hyaluronic acid can be prepared by fermentation of bacteria such as streptococci. The bacteria are incubated in a sugar rich broth, and the produced hyaluronic acid is separated from impurities and purified. The molecular weight of hyaluronic acid produced via fermentation can be set by the sugars placed in the fermentation broth. Hyaluronic acid produced via fermentation can be obtained from companies Freda-Bausch and Lomb and Fidia.

In its natural form, hyaluronic acid has a molecular weight in the range of 5×10⁴ up to 1×10⁷ daltons. Its molecular weight may be reduced via a number of cutting processes such as exposure to acid, heat (e.g. autoclave, microwave, dry heat), or ultrasonic waves.

The ophthalmic compositions can also include a phosphonic acid, or its physiologically compatible salt, represented by the following formula:

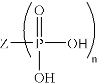

wherein Z is a connecting radical equal, n is an integer from 1 to 4, or 1, 2 or 3, and preferably containing 1 to 12 carbon atoms, more preferably 3 to 10 carbon atoms. The Z radical comprises substituted or unsubstituted saturated hydrocarbon radicals or amine-containing radicals, which amine-containing radicals are saturated hydrocarbon radicals in which the carbon atoms are interrupted with at least one nitrogen atom such as 1, 2 or 3 nitrogen atoms that forms a secondary or tertiary amine.

Accordingly, suitable Z radicals include substituted or unsubstituted alkylidene, substituted or unsubstituted alkylene, amino tri(alkylene) having at least n+1 carbon atoms, amino di(alkylene) having at least n+1 carbon atoms, alkylenediaminetetra(alkylene) or a dialkylenetriamine penta(alkylene) radical. In each case, the alkylene group in parenthesis is connected to a phosphonic acid group. Preferably, all alkylene groups independently have 1 to 4 carbon atoms.

Exemplary compounds in which the Z group is an amino tri(alkylene) radical includes amino tri(ethylidene phosphonic acid), amino tri(isopropylidene phosphonic acid), amino di(methylene phosphonic acid) mono(isopropylidene phosphonic acid), and amino mono(methylene phosphonic acid) di(ethylidene phosphonic acid). Exemplary compounds in which the Z group is a substituted or unsubstituted alkylidene radical includes methylene diphosphonic acid, ethylidine diphosphonic acid, 1-hydroxy propylidene diphosphonic acid. Exemplary compounds in which the Z group is an alkylenediaminetetra(alkylene) or a dialkylenetriamine penta(alkylene) radical include hexamethylenediaminetetra(methylene phosphonic acid) and diethylenetriaminepenta(methylenephosphonic acid).

In one embodiment, the phosphonic acid, or its physiologically compatible salt, is represented by the following formula:

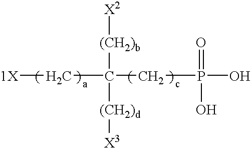

wherein each of a, b, c, and d are independently selected from integers from 0 to 4, preferably 0 or 1; X¹ is a phosphonic acid group (i.e., P(OH)₂O), hydroxy, amine or hydrogen; and X² and X³ are independently selected from the group consisting of halogen, hydroxy, amine, carboxy, alkylcarbonyl, alkoxycarbonyl, or substituted or unsubstituted phenyl, and methyl. Exemplary substituents on the phenyl are halogen, hydroxy, amine, carboxy and/or alkyl groups. A particularly preferred species is that wherein a, b, c, and d in are zero, specifically the tetrasodium salt of 1-hydroxyethylidene-1,1-diphosphonic acid, also referred to as tetrasodium etidronate, commercially available from Monsanto Company as DeQuest® 2016 diphosphonic acid sodium salt or phosphonate.

The ophthalmic composition can also include dexpanthenol, which is an alcohol of pantothenic acid, also called Provitamin B5, D-pantothenyl alcohol or D-panthenol. In some formulations of the lens care compositions, dexpanthenol can exhibit good cleansing action and can stabilize the lachrymal film at the eye surface when placing a contact lens on the eye. Dexpanthenol is preferably present in the contact lens care compositions in an amount from 0.2% to 10% (w/v), from 0.5% to 5% (w/v), or from 1% to 3% (w/v).

The ophthalmic composition can also include sorbitol, which is a hexavalent sugar alcohol. Typically, dexpanthenol is used in combination with sorbitol. In specific formulations the combination dexpanthenol and sorbitol can provide enhanced cleansing action and can also stabilize the lachrymal film following placement of the contact lens on the eye. These formulations can substantially improve patient comfort when wearing contact lenses. Sorbitol is present in the lens care compositions in an amount from 0.4% to 6% (w/v), from 0.8% to 4% (w/v) or from 1% to 3% (w/v).

The ophthalmic composition can also include one or more oils or oily substances. Any suitable oil or oily substance or combinations of oils or oily substances can be used provided such oils do not cause any substantial or significant detrimental effect to the patient or to a contact lens. The oil component can be a natural or synthetic oil. Natural oils can be obtained from plants or plant parts such as seeds, or they may be obtained from an animal source such as Sperm Whale oil, Cod liver oil and the like. The oil may be a mono, di or triglyceride of fatty acids or mixtures of glycerides. The oil may also be comprised of straight chain monoethylene acids and alcohols in the form of esters such as Jojoba and Sperm Whale oil.

The ophthalmic composition can also include one or more neutral or basic amino acids. The neutral amino acids include: the alkyl-group-containing amino acids such as alanine, isoleucine, valine, leucine and proline; hydroxyl-group-containing amino acids such as serine, threonine and 4-hydroxyproline; thio-group-containing amino acids such as cysteine, methionine and asparagine. Examples of the basic amino acid include lysine, histidine and arginine. The one or more neutral or basic amino acids are present in the compositions at a total concentration of from 0.1% to 5% (w/v).

The ophthalmic composition can also include glycolic acid, asparatic acid, or an α-hydroxy acid or any mixture thereof at a total concentration of from 0.001% to 4% (w/v) or from 0.01% to 2.0% (w/v).

In addition, the combined use of one or more amino acids and glycolic acid, asparatic acid or α-hydroxy acid can minimize the dimensional change of the contact lens due to swelling and shrinkage following placement of the lens on the eye. The stated combination provides a higher degree of compatibility with the contact lens.

The ophthalmic composition can also include 2-amino-2-methyl-1,3-propanediol or a salt thereof (AMPD). Preferably, the AMPD is added to the solutions in an amount to satisfy a predetermined molar ratio of glycolic acid, asparatic acid, α-hydroxy acid or any mixture thereof and AMPD. The molar ratio of glycolic acid, asparatic acid, α-hydroxy acid or any mixture thereof to AMPD is 1:20 to 1.3:1, from 1:15 to 1.2:1 or from 1:14 to 1:1. The glycolic acid, asparatic acid, α-hydroxy acid or any mixture thereof is present in the compositions at a concentration of 0.01% to 5% (w/v) or at a concentration of 0.05% to 1% (w/v).

The ophthalmic composition will very likely include a buffer system. By the terms “buffer” or “buffer system” is meant a compound that, usually in combination with at least one other compound, provides a buffering system in solution that exhibits buffering capacity, that is, the capacity to neutralize, within limits, either acids or bases (alkali) with relatively little or no change in the original pH. Generally, the buffering components are present from 0.05% to 2.5% (w/v) or from 0.1% to 1.5% (w/v).

The term “buffering capacity” is defined to mean the millimoles (mM) of strong acid or base (or respectively, hydrogen or hydroxide ions) required to change the pH by one unit when added to one liter (a standard unit) of the buffer solution. The buffer capacity will depend on the type and concentration of the buffer components. The buffer capacity is measured from a starting pH of 6 to 9.

Borate buffers include, for example, boric acid and its salts, for example, sodium borate or potassium borate. Borate buffers also include compounds such as potassium tetraborate or potassium metaborate that produce borate acid or its salt in solutions. Borate buffers are known for enhancing the efficacy of certain polymeric biguanides. For example, U.S. Pat. No. 4,758,595 to Ogunbiyi et al. describes that a contact-lens solution containing a polyaminopropyl biguanide (PAPB), also known as PHMB, can exhibit enhanced efficacy if combined with a borate buffer.

A phosphate buffer system preferably includes one or more monobasic phosphates, dibasic phosphates and the like. Particularly useful phosphate buffers are those selected from phosphate salts of alkali and/or alkaline earth metals. Examples of suitable phosphate buffers include one or more of sodium dibasic phosphate (Na₂HPO₄), sodium monobasic phosphate (NaH₂PO₄) and potassium monobasic phosphate (KH₂PO₄). The phosphate buffer components frequently are used in amounts from 0.01% or to 0.5% (w/v), calculated as phosphate ion.

Other known buffer compounds can optionally be added to the lens care compositions, for example, citrates, sodium bicarbonate, TRIS, and the like. Other ingredients in the solution, while having other functions, may also affect the buffer capacity. For example, EDTA, often used as a complexing agent, can have a noticeable effect on the buffer capacity of a solution.

A preferred buffer system is based upon boric acid/borate, a mono and/or dibasic phosphate salt/phosphoric acid or a combined boric/phosphate buffer system. For example a combined boric/phosphate buffer system can be formulated from a mixture of sodium borate and phosphoric acid, or the combination of sodium borate and the monobasic phosphate.

In a combined boric/phosphate buffer system, the solution comprises about 0.05 to 2.5% (w/v) of a phosphoric acid or its salt and 0.1 to 5.0% (w/v) of boric acid or its salt. The phosphate buffer is used (in total) at a concentration of 0.004 to 0.2 M (Molar), preferably 0.04 to 0.1 M. The borate buffer (in total) is used at a concentration of 0.02 to 0.8 M, preferably 0.07 to 0.2 M.

The ophthalmic composition can also include a water-soluble borate-polyol complex which can be formed by mixing a source of borate with a polyol of choice in an aqueous solution. These complexes can be used in conjunction with the antimicrobial component above, and can help to meet preservative efficacy and disinfection standards. In such compositions, the molar ratio of borate to polyol is generally from 1:0.1 to 1:10, or from 1:0.25 to 1:2.5. If present in the lens care solutions, the borate-polyol complex is usually present from 0.5% to 5% (w/v), from 1.0% to 2.5% (w/v). The borate-polyol complexes are described in greater detail in U.S. Pat. No. 6,143,799.

The ophthalmic composition will very likely comprise effective amounts of one or more of the following formulation components; a surfactant component, a viscosity inducing or thickening component, a chelating or sequestering component, or a tonicity component. The additional component or components can be selected from materials which are known to be useful in contact lens care solutions and are included in amounts effective to provide the desired effect or benefit.

Suitable surfactants can be either amphoteric, cationic, anionic, or nonionic, and are typically present (individually or in combination) in amounts up to 8%, or up to 3% (w/v). One preferred surfactant class are the amphoteric or nonionic surfactants. The surfactant should be soluble in the lens care solution and non-irritating to eye tissues. Many nonionic surfactants comprise one or more chains of polymeric components having oxyalkylene (—O—R—) repeats units wherein R has 2 to 6 carbon atoms. Preferred non-ionic surfactants comprise block polymers of two or more different kinds of oxyalkylene repeat units, which ratio of different repeat units determines the HLB of the surfactant. Satisfactory non-ionic surfactants include polyethylene glycol esters of fatty acids, e.g. polysorbate. Examples of this class include polysorbate 20 (available under the trademark Tween® 20), polyoxyethylene (23) lauryl ether (Brij® 35), polyoxyethyene (40) stearate (Myrj® 52), polyoxyethylene (25) propylene glycol stearate (Atlas® G 2612). Still other preferred surfactants include tyloxapol, polysulfates, polyethylene glycol, alkyl esters and any mixture thereof.

A particular non-ionic surfactant consisting of a poly(oxypropylene)-poly(oxyethylene) adduct of ethylene diamine having a molecular weight from about 7,500 to about 27,000 wherein at least 40 weight percent of said adduct is poly(oxyethylene) has been found to be particularly advantageous for use in cleaning and conditioning both soft and hard contact lenses when used in amounts from about 0.01 to about 15 weight percent. The CTFA Cosmetic Ingredient Dictionary's adopted name for this group of surfactants is poloxamine. Such surfactants are available from BASF Wyandotte Corp., Wyandotte, Mich., under Tetronic®.

An analogous of series of surfactants, for use in the lens care compositions, is the poloxamer series which is a poly(oxyethylene) poly(oxypropylene) block polymers available under Pluronic® (commercially available form BASF). In accordance with one embodiment of a lens care composition the poly(oxyethylene)-poly(oxypropylene) block copolymers will have molecular weights from 2500 to 13,000 daltons or from 6000 to about 12,000 daltons. Specific examples of surfactants which are satisfactory include: poloxamer 108, poloxamer 188, poloxamer 237, poloxamer 238, poloxamer 288 and poloxamer 407. Particularly good results are obtained with poloxamer 237.

Various other ionic as well as amphoteric and anionic surfactants suitable for in the invention can be readily ascertained, in view of the foregoing description, from McCutcheon's Detergents and Emulsifiers, North American Edition, McCutcheon Division, MC Publishing Co., Glen Rock, N.J. 07452 and the CTFA International Cosmetic Ingredient Handbook, Published by The Cosmetic, Toiletry, and Fragrance Association, Washington, D.C.

Amphoteric surfactants suitable for use in a composition according to the present invention include materials of the type are offered commercially under the trade name “Miranol.” Another useful class of amphoteric surfactants is exemplified by cocoamidopropyl betaine, commercially available from various sources.

The foregoing surfactants will generally be present in a total amount from 0.01% to 5% (w/v), from 0.1% to 3% (w/v), or from 0.1% to 1.5% (w/v). Often the amount of surfactant is from 0.005% or 0.01%, to 0.1% or 0.5% or 0.8% (w/v).

The ophthalmic compositions can also include a viscosity enhancing component. The viscosity inducing components should be compatible with the other components and are preferably nonionic. Such viscosity inducing components are effective to enhance and/or prolong the cleaning and wetting activity of the surfactant component and/or condition the lens surface rendering it more hydrophilic (less lipophilic) and/or to act as a demulcent on the eye. Increasing the solution viscosity provides a film on the lens which may facilitate comfortable wearing of the contact lens. The viscosity inducing component can also function to cushion the impact on the eye surface during placement of the lens and serves also to alleviate eye irritation.

Suitable viscosity inducing components include, but are not limited to, water soluble natural gums, cellulose-derived polymers and the like. Useful natural gums include guar gum, gum tragacanth and the like. Useful cellulose-derived viscosity inducing components include cellulose-derived polymers, such as hydroxypropyl cellulose, hydroxypropylmethyl cellulose, carboxymethyl cellulose, methyl cellulose, hydroxyethyl cellulose and the like. A very useful viscosity inducing component is hydroxypropylmethyl cellulose (HPMC). Another useful viscosity inducing component is a polymer comprising monomeric units of 2-methacryloyloxy ethyl phosphorylcholine (MPC), which is available under the tradename Lipidure® from NOF Corporation.

The viscosity inducing component is used in an amount effective to increase the viscosity of the solution, preferably to a viscosity in the range of 1.5 to 30, or even as high as 750, cps at 25° C., as determined by USP test method No. 911 (U.S. Pat. No. 23,1995).

A chelating or sequestering can be included in an amount effective to enhance the effectiveness of the cationic antimicrobial component and/or to complex with metal ions to provide more effective cleaning of the contact lens. A wide range of organic acids, amines or compounds which include an acid group and an amine function are capable of acting as chelating components. For example, nitrilotriacetic acid, diethylenetriaminepentacetic acid, hydroxyethylethylene-diaminetriacetic acid, 1,2-diaminocyclohexane tetraacetic acid, hydroxyethylaminodiacetic acid, ethylenediamine-tetraacetic acid and its salts, polyphosphates, citric acid and its salts, tartaric acid and its salts, and the like and mixtures thereof, are useful as chelating components. Ethylenediaminetetraacetic acid (EDTA) and its alkali metal salts, are preferred, with disodium salt of EDTA, also known as disodium edetate, being one of the preferred chelating components.

The ophthalmic composition will typically include an effective amount of a tonicity adjusting component. Among the suitable tonicity adjusting components that can be used are those conventionally used in contact lens care products such as various inorganic salts. Sodium chloride and/or potassium chloride and the like are very useful tonicity components. The amount of tonicity adjusting component is effective to provide the desired degree of tonicity to the solution.

The ophthalmic composition will have an osmolality from 200 mOsmol/kg to 400 mOsmol/kg or from 260 mOsmol/kg to 350 mOsmol/kg. The lens care solutions are substantially isotonic or hypertonic (for example, slightly hypertonic) and are ophthalmically acceptable.

Accordingly, the ophthalmic compositions can be a disinfecting/cleaning solution for contact lenses. In general, such a method would include contacting or soaking the lenses with the solution for a period of time, typically for a minimum of one to four hours. Although such contacting may be accomplished by simply soaking a lens in the ophthalmic composition, greater preserving, disinfecting and/or cleaning may possibly be achieved if a few drops of the solution are initially placed on each side of the lens, and the lens is rubbed for a period of time, for example, approximately 20 seconds. The lens can then be subsequently immersed within several milliliters of the solution. Preferably, the lens is permitted to soak in the solution for at least four hours. Furthermore, the lens is preferably rinsed with fresh composition after any rubbing step and again after being immersed within the solution. The lenses are removed from the solution, rinsed with the same or a different solution, for example, a preserved isotonic saline solution, and repositioned on the eye.

The ophthalmic compositions can also be formulated for use as a preservative solution or a packaging solution for contact lenses. One of ordinary skill in the art would know how to adjust the formulation for each of these respective applications. The lens care compositions in combination with its container or bottle and packaging, including instructions for use in accordance with a specified regimen, provides an improved kit, package, or system for the care of contact lenses.

The ophthalmic composition can be formulated for use with many different types of contact lenses including: (1) hard lenses formed from materials prepared by polymerization of acrylic esters, such as poly(methyl methacrylate) (PMMA), (2) rigid gas permeable (RGP) lenses formed from silicone acrylates and fluorosilicone methacrylates, (3) soft, hydrogel lenses, and (4) non-hydrogel elastomer lenses.

As an example, soft hydrogel contact lenses are made of a hydrogel polymeric material, a hydrogel being defined as a crosslinked polymeric system containing water in an equilibrium state. In general, hydrogels exhibit excellent biocompatibility properties, i.e., the property of being biologically or biochemically compatible by not producing a toxic, injurious or immunological response in a living tissue. Representative conventional hydrogel contact lens materials are made by polymerizing a monomer mixture comprising at least one hydrophilic monomer, such as (meth)acrylic acid, 2-hydroxyethyl methacrylate (HEMA), glyceryl methacrylate, N,N-dimethacrylamide, and N-vinylpyrrolidone (NVP). In the case of silicone hydrogels, the monomer mixture from which the copolymer is prepared further includes a silicone-containing monomer, in addition to the hydrophilic monomer. Generally, the monomer mixture will also include a crosslink monomer such as ethylene glycol dimethacrylate, tetraethylene glycol dimethacrylate, and methacryloxyethyl vinylcarbonate. Alternatively, either the silicone-containing monomer or the hydrophilic monomer may function as a crosslink agent.

### EXAMPLES

### Example 1

### Preparation of Copolymer of Glyceryl Methacrylate and Acrylic Acid

A 500-ml round-bottom flask was connected with a nitrogen inlet and a condenser. The flask was immersed in an oil bath and charged with 240 mL deionized water. The following reagents were added to the flask through a syringe −6.417g (40.06 mmol) glyceryl methacrylate, 0.722g (10.02 mmol) acrylic acid, and 0.086g (0.524 mmol) AIBN polymerization initiator. The contents of the flask were bubbled with nitrogen for 20 minutes. The nitrogen flow was reduced to a lower rate, and the flask was heated to and maintained at 70° C. under nitrogen purge for two days. The mixture was then cooled to room temperature and saved as 3% solution.

The copolymer of Example 1 was formulated at 0.1% with 3 ppm alexidine in 50 mM sodium phosphate buffer at pH 7.2. The disinfection efficacy of the formulation was tested following the Stand-alone Biocidal procedure outlined in ISO 14729, International Standardized Document for Ophthalmic Optics and FDA Premarket Notification (510k) Guidance Document for Contact Lens Care Products. For comparison purpose, a control (no polymer) and two Carbomer samples (934P and 941) were formulated in the same manner and tested in the study. The results are summarized in Table 1.

### Example 2

### Preparation of Copolymer of N-vinylpyrrolidone and Methacrylic Acid

Distilled N-vinylpyrrolidone (NVP, 5.38 g, 48 mmoles) and methacrylic acid, 0.384 g, 4.8 mmoles), Vazo-64 (AIBN, 0.05 g, 0.3 mmoles) and distilled THF (60 ml) are added to a one liter reaction flask fitted with a magnetic stirrer, condenser, thermal controller, and a nitrogen inlet. Nitrogen is bubbled through the solution for 15 min to remove any dissolved oxygen. The reaction flask is heated to 60° C. under nitrogen for 16 hrs. The resulting reaction mixture is slowly added to 3L of ethyl ether with good mechanical stirring. The copolymer precipitates and is collected by vacuum filtration. The collected solid is placed in a vacuum oven at 30° C. overnight to removeany remaining ether. The copolymer is placed in a desiccator for storage until use.

TABLE 1

| | time | Log Reduction | | | | |
|---|---|---|---|---|---|---|
| Polymer | (hr) | Sa | Pa | Sm | Ca | Fs |
| none | 1 | 2.1 | >5.0 | 2.7 | 0.1 | 2.5 |
| | 4 | 3.5 | >5.0 | >4.9 | 1.0 | 4.3 |
| Carbomer 934P | 1 | 0.2 | 2.1 | TNTC | 0 | 0.4 |
| | 4 | TNTC | 3.4 | 1.1 | 0.1 | TNTC |
| Carbomer 941 | 1 | 0.2 | 1.9 | TNTC | 0 | 0.5 |
| | 4 | TNTC | 3.2 | 1.0 | 0.2 | TNTC |
| Example 1 | 1 | 0.6 | 1.9 | 1.6 | 0 | 1.1 |
| | 4 | 1.1 | 3.4 | 3.3 | 0.2 | 1.9 |

Sa; Staphylococcus aureus (ATCC 6538)
Pa; Pseudomonas aeruginosa (ATCC 9027)
Sm; Serratia marcescens (ATCC 13880)
Ca; Candida albicans (ATCC 10231)
Fs; Fusarium solani (ATCC 36031)
TNTC; Too numerous to count

### Example 3

### Preparation of PHMB-CG

PHMB (Cosmocil® 100, 6.0 g, 3.3 mmol) (Cosmocil® 100 is a solid form of PHMB), hexamethylene bis(cyanoguanido) (HMBDA) (1.8 g, 7.2 mmol) and concentrated hydrochloric acid (720 μL) are added to a reaction flask and heated to 100° C. until most of the liquid dissipates from the flask. The temperature of the reaction mixture is then heated to 155° C. for one to four hours, which can vary the percent of cyanoguanidino terminal groups of the PHMB-CG*. The reaction is allowed to cool overnight to room temperature over a flow of nitrogen. The resulting solids are dissolved in 60 mL of distilled water and solution purified by dialysis (100 MWCO tubing) overnight. The purified product is then freeze dried overnight.

### Example 4

### Preparation of PHMB-CG

An aqueous solution containing sodium dicyanimide (8.9 g), hexamethylene (11.6 g), HMBDA (8.9 g), 36% hydrochloric acid (19 g) and water (7.3 g) is prepared with a pH from 6.5 to 7.5. The solution is heated to 120° C. to remove all of the water. The reaction vessel is then heated to 150° C. and this temperature is maintained for four hours. The reaction is cooled overnight under nitrogen. The resulting solids are dissolved in 60 mL of distilled water and solution purified by dialysis (100 MWCO tubing) overnight. The purified product is then freeze dried overnight. A biguanide product comprising less than 18 mol % of terminal amine groups and 40 mol % and greater of terminal cyanoguanidino groups is obtained as measured by ¹³C NMR.

### ¹³C NMR Pulse Sequence and Acquisition Parameters

The resulting polymeric biguanide compositions provided by the Examples 1 to 5 above are analyzed by ¹³C NMR to determine the molar concentration of terminal end groups in each Example composition. The special pulse technique used to acquire the ¹³C spectra allows one to quantify the relative concentration of each terminal end group, that is, a guanidine, a cyanoguanidino or an amine. The ¹³C NMR data is also used to quantify the relative concentrations of in-chain biguanide groups and in-chain guanide. A representative ¹³C NMR spectrum of one of the polymeric biguanides of the invantioin is shown in FIG. 1. As indicated, the alpha-methylene carbon associated with the terminal amine group is indicated by peak A, the guanidine carbon associated with the terminal guanidine group is indicated by peak B and the guanidine carbon associated with the terminal cyanoguanidino group is indicated by peak C. Also, the carbon associated with the in-chain biguanide is indicated by peak D, and the carbon associated with the in-chain guanide is indicated by peak E.

The samples for ¹³C NMR analysis are prepared using 2.2 ml of polymeric biguanide (20 wt %) in water and 0.3 ml D₂O is added. High-resolution ¹³C NMR is acquired using a Bruker AVANCE 300 MHz spectrometer operating at 75.5 MHz for ¹³C nuclei. For quantitative analysis, spectra are acquired using single-pulse excitation with inverse-gated decoupling for suppression of NOE effects, 1024 transients, and a relaxation delay that is five times longer than the longest ¹³C T₁ in the sample. At 300 MHz, the longest T, observed is 9.0 seconds for the terminal guanidine carbon at ˜157 ppm. A relaxation delay of 45 seconds is used to acquire quantitative spectra at 300 MHz. Since T₁'s are magnetic field dependent, it will be necessary to run a relaxation experiment if acquiring at a different field strength. All spectra are acquired at 300 K using a 10 mm BBO probe.

We claim:

1. An ophthalmic composition comprising:
a copolymer comprising monomeric units of one or more polymerizable alcohols or polymerizable polyols, and monomeric units of one or more polymerizable carboxylic acids; and
one or more antimicrobial components, wherein the composition has an osmolality from 200 mOsmol/kg to 400 mOsmol/kg.

2. The composition of claim 1 wherein the copolymer has a mole ratio of monomeric units of the polymerizable alcohol or polyol to the monomeric units of the polymerizable carboxylic acid of from 2 to 20.

3. The composition of claim 1 wherein the polymerizable polyols are selected from the group consisting of erythritol (meth)acrylate, xylitol (meth)acrylate, sorbitol (meth)acrylate, and derivatives thereof.

4. The composition of claim 1 wherein the polymerizable alcohols are selected from the group consisting of glyceryl (meth)acrylate, 4-vinylcyclohexyl-1,2-epoxide, vinyl alcohol and derivatives thereof.

5. The composition of claim 1 wherein the monomeric units of polymerizable carboxylic acids are selected from the group consisting of (meth)acrylic acid, vinyl derivatives of carboxyalkyl cellulose, vinyl glutamic acid, vinyl aspartic acid and derivatives thereof.

6. The composition of claim 1 wherein the antimicrobial component is a cationic antimicrobial component selected from the group consisting of cetylpyridinium chloride, α-[4-tris(2-hydroxyethyl)ammonium chloride-2-butenyl]poly[1-dimethyl ammonium chloride-2-butenyl]-ω-tris(2-hydroxyethyl)ammonium chloride, myristamidopropyl dimethylamine, benzalkonium halides, alexidine and salts thereof and hexamethylene biguanides and salts thereof and their polymers.

7. The composition of claim 6 wherein the cationic antimicrobial component is selected from the group consisting of PHMB or PHMB-CG, which is present from 0.01 ppm to 3 ppm, α-[4-tris(2-hydroxyethyl)ammonium chloride-2-butenyl]poly[1-dimethylammonium chloride-2-butenyl]-ω-tris(2-hydroxyethyl) ammonium chloride, which is present from 1 ppm to 100 ppm, and any mixture thereof.

8. The composition of claim 1 further comprising dexpanthenol, sorbitol or any mixture thereof.

9. The composition of claim 1 further comprising 2-amino-2-methyl-1,3-propanediol, and glycolic acid, aspartic acid or a mixture thereof, wherein a molar ratio of the total glycolic acid, aspartic acid or mixture thereof to AMPD is from 1:20 to 1.3:1.

10. The composition of claim 1 further comprising hyaluronic acid.

11. The use of the ophthalmic composition of claim 1 in an eye care or a contact lens care product selected from the group consisting of eye drops, contact lens preservative solution, contact lens packaging solution, and contact lens multi-purpose solution.

12. An ophthalmic composition that includes a copolymer comprising monomeric units of glyceryl (meth)acrylate and monomeric units of (meth)acrylic acid, and one or more cationic antimicrobial components, wherein the composition has an osmolality from 200 mOsmol/kg to 400 mOsmol/kg.

13. The composition of claim 12 wherein the copolymer has a mole ratio of monomeric units of glyceryl (meth)acrylate and monomeric units of (meth)acrylic acid of from 2 to 12.

14. The composition of claim 12 wherein the cationic antimicrobial component is selected from the group consisting of cetylpyridinium chloride, α-[4-tris(2-hydroxyethyl)ammonium chloride-2-butenyl]poly[1-dimethyl ammonium chloride-2-butenyl]-ω-tris(2-hydroxyethyl)ammonium chloride, myristamidopropyl dimethylamine, benzalkonium halides, alexidine and salts thereof, hexamethylene biguanides and salts thereof and their polymers, and mixtures thereof.

15. The composition of claim 12 wherein the cationic antimicrobial component is selected from the group consisting of PHMB or PHMB-CG, which is present from 0.01 ppm to 3 ppm, α-[4-tris(2-hydroxyethyl) ammonium chloride-2-butenyl]poly[1-dimethylammonium chloride-2-butenyl]-ω-tris(2-hydroxyethyl) ammonium chloride, which is present from 1 ppm to 100 ppm, and any mixture thereof.

16. The composition of claim 12 further comprising dexpanthenol, sorbitol or any mixture thereof.

17. The composition of claim 12 further comprising 2-amino-2-methyl-1,3-propanediol, and glycolic acid, aspartic acid or a mixture thereof, wherein a molar ratio of the total glycolic acid, aspartic acid or mixture thereof to AMPD is from 1:20 to 1.3:1.

18. The composition of claim 12 further comprising hyaluronic acid.

19. An ophthalmic composition that includes a copolymer comprising monomeric units of N-vinylpyrrolidone and monomeric units of one or more polymerizable carboxylic acids, and one or more cationic antimicrobial components, wherein the composition has an osmolality from 200 mOsmol/kg to 400 mOsmol/kg.

20. The composition of claim 19 wherein the copolymer has a mole ratio of monomeric units of the N-vinylpyrrolidone to the monomeric units of the polymerizable carboxylic acid of from 4 to 20.
